(19) United States
(12) Patent Application Publication
(10) Pub. No.: US 2013/0074507 A1
(43) Pub. Date: Mar. 28, 2013

(54) COMBUSTION LINER FOR A TURBINE ENGINE

(71) Applicants: Karthick KALEESWARAN, Bangalore (IN); Sridhar K. V, Bangalore (IN)

(72) Inventors: Karthick KALEESWARAN, Bangalore (IN); Sridhar K. V, Bangalore (IN)

(21) Appl. No.: 13/247,008

(22) Filed: Sep. 28, 2011

(51) Int. Cl. F23R 3/42; B23P 17/00

(52) U.S. Cl. 60/754; 29/888

(57) ABSTRACT

A combustion liner for a combustor of a turbine engine includes a plurality of undulations which extend around the exterior circumference of the combustion liner. A plurality of rows of cooling holes are formed through the combustion liner. Each row of cooling holes is located in one of the undulations which extends around the exterior circumference of the combustion liner. The cooling holes admit a flow of cooling air into the interior of the combustion liner. The cooling holes are located and oriented to help the flow of cooling air form a film along the inner surface of the combustion liner.

### BACKGROUND OF THE INVENTION

A turbine engine used in the power generation industry typically includes a compressor section, a combustor section, and a turbine section. The combustor section typically includes a plurality of combustors which are arranged around the exterior circumference of the turbine engine.

FIG. 1 illustrates portions of a typical combustor of a turbine engine. The combustor 100 includes an outer housing 110 with a combustion liner located inside the outer housing 110. The combustion liner could include a primary combustion section liner 120, a venturi section 130, and a secondary combustion section liner 140.

Compressed air from the compressor section of the turbine engine travels along an annular space formed between the combustion liner and the outer housing 110, as illustrated by the arrows in FIG. 1. The compressed air travels to a head end, where it turns 180° and is then directed into a primary combustion zone 160 located inside the primary combustion section liner 120. Fuel is mixed with the compressed air in the primary combustion section 160. The air fuel mixture is ignited either in the primary combustion section 160 or in a secondary combustion section 170. A fuel nozzle 150 may protrude through the center of the combustion liner to deliver more fuel, or a mixture of air and fuel, into the interior of the combustion liner just upstream of the venturi section 130.

As illustrated in FIG. 1, a plurality of cooling holes 122 are formed through the primary combustion liner 120 surrounding the primary combustion section 160. The cooling holes 122 are formed in rows which extend around the outer circumference of the combustion liner 120. The cooling holes 122 allow compressed air from the annular space between the combustion liner 120 and the outer housing 110 to enter into the interior of the combustion liner 120. The flow of air through the cooling holes 122 helps to cool the combustion liner 120 so that it can withstand the heat associated with the combustion of the air/fuel mixture.

One way to enhance the cooling effect of the cooling air which is admitted into the interior of the combustion liner through the cooling holes, is to ensure that the air passing into the combustion liner forms a film on the inner surface of the combustion liner. FIG. 2 illustrates a typical prior art combustion liner 220 which has been modified to help the cooling air form a film on the inner surface of a combustion liner 220.

As illustrated in FIG. 2, a plurality of louvers 226 are mounted on the inner surface of the combustion liner 220 immediately adjacent to the cooling holes 222. The louvers 226 form a ring around the inner surface of the combustion liner 220. When cooling air is admitted through the cooling holes 222, the louvers 226 help to direct the cooling airflow along the inner surface of the combustion liner 220 to enhance the cooling performance of the air being admitted through the cooling holes 222.

Unfortunately, there is a cost associated with the louvers 226, and also with the manufacturing process required to attach the louvers 226 to the interior surface of the combustion liner 220. Further, the brazed joint used to attach the louvers 226 to the inner surface of the combustion liner 220 can be relatively weak. Also, the presence of the louvers 226 makes it difficult to apply a thermal barrier coating to the inner surface of the combustion liner.

### BRIEF DESCRIPTION OF THE INVENTION

In a first aspect, the invention is embodied in a generally cylindrical combustion liner for a combustor of a turbine engine that includes a plurality of undulations. Each undulation extends around a circumference of the cylindrical liner. Each undulation includes a portion that extends inward toward a central longitudinal axis of the cylindrical liner. No louvers or inner rings are mounted on an inner surface of the cylindrical liner. The liner also includes a plurality of cooling holes that extend through the cylindrical liner, the cooling holes being arranged in a plurality of rows, each row of cooling holes being provided in one of the undulations.

In a second aspect, the invention is embodied in a method of forming a combustion liner for a turbine engine that includes the steps of providing a generally cylindrical liner, and forming a plurality of undulations in the liner, each undulation extending around a circumference of the cylindrical liner. Each undulation also including a portion that extends inward toward a central longitudinal axis of the cylindrical liner, and no louvers or inner rings are mounted on an inner surface of the cylindrical liner. The method also includes a step of forming a plurality of cooling holes in the liner, the cooling holes extending through the cylindrical liner, the cooling holes being arranged in a plurality of rows, each row of cooling holes being provided in one of the undulations.

### BRIEF DESCRIPTION OF THE DRAWINGS

FIG. 1 is a diagram of a portion of a combustor of a turbine engine;

FIG. 2 illustrates a portion of a combustion liner of a turbine engine;

FIG. 3 illustrates a portion of a combustion liner with inward projecting portions;

FIG. 4 illustrates a portion of a combustion liner which includes inward and outward projecting portions;

FIG. 5 illustrates a portion of a combustion liner with inward and outward projecting portions and a thermal barrier coating;

FIG. 6 illustrates a portion of another embodiment of a combustion liner with inward and outward projecting portions; and

FIG. 7 illustrates a portion of another embodiment of a combustion liner which includes inward and outward projecting portions.

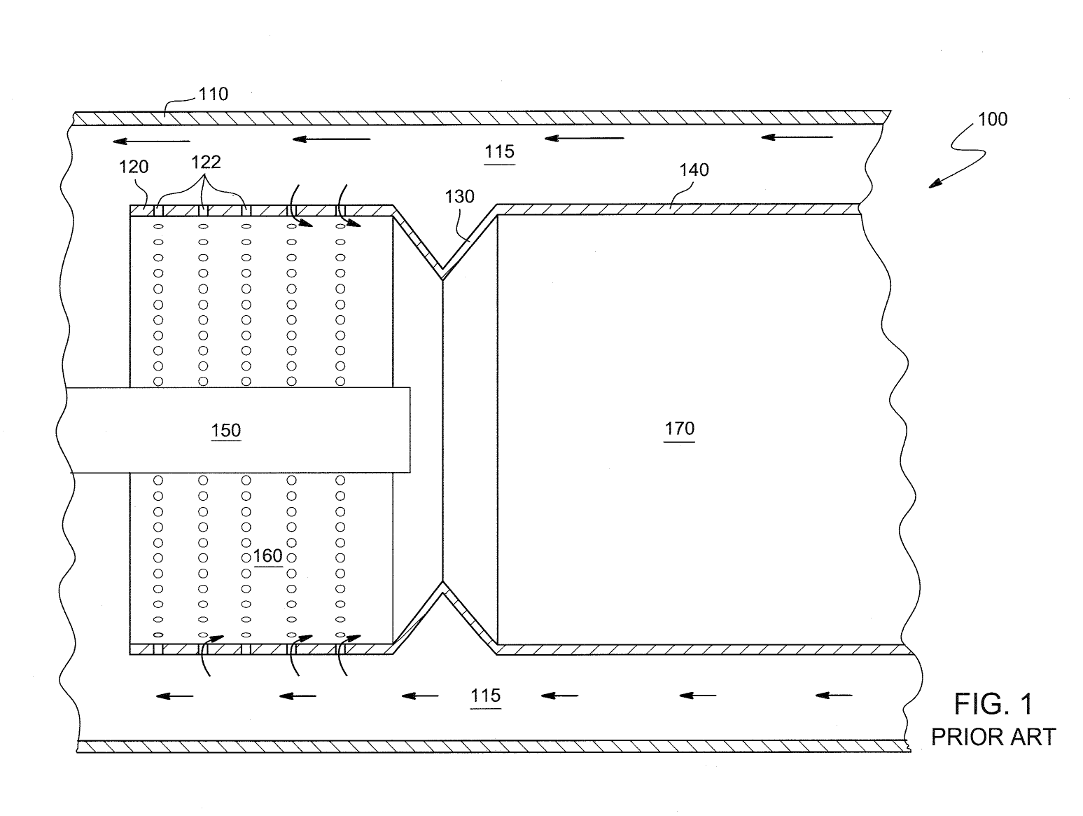

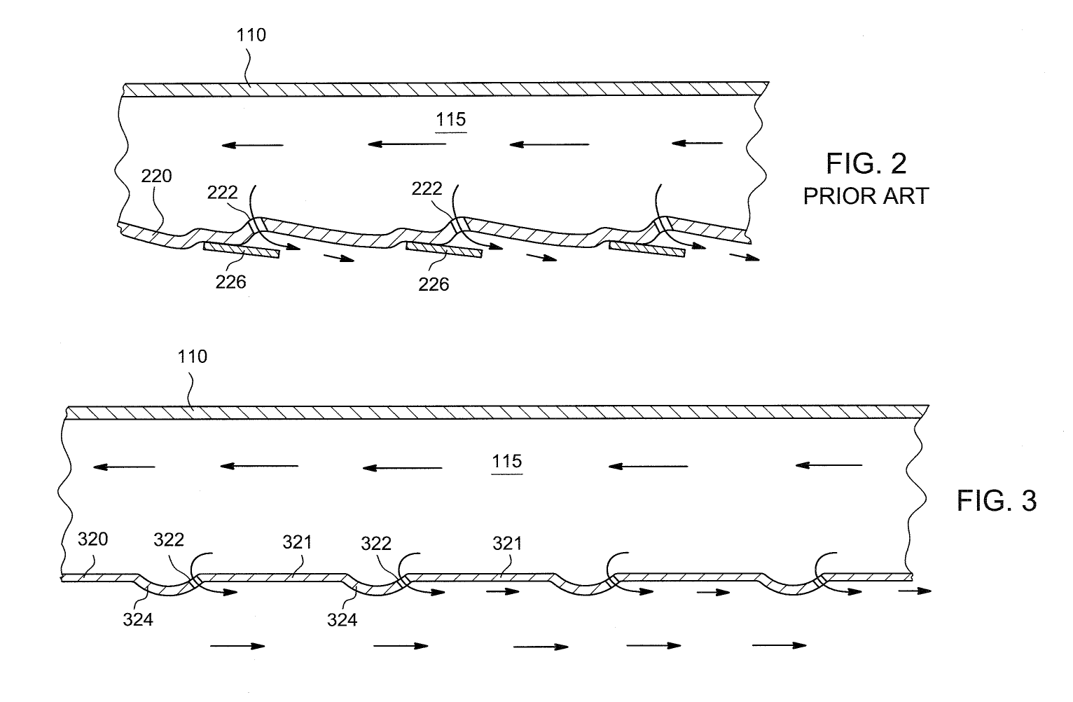

### DETAILED DESCRIPTION OF THE INVENTION

A first embodiment of a combustion liner embodying the invention is illustrated in FIG. 3. The combustion liner 320 includes a plurality of undulations formed of inwardly projecting portions 324. The undulations increase the rigidity and strength of the cylindrical combustion liner 320. In addition, rows of cooling holes 322 are formed through the combustion liner 320. Each row of cooling holes 322 is formed along one of the undulations that extend around the circumference of the combustion liner.

Arrows in FIG. 3 illustrate the flow of compressed air which is traveling down the annular space 115 between the combustion liner 320 and the outer housing 110. Arrows also illustrate the flow path of the air fuel mixture located in the interior of the combustion liner 320. Arrows further illustrate how the compressed air in the annular space 115 travels from the annular space 115, through the cooling holes 322, and into the interior of the combustion liner 320.

As also illustrated in FIG. 3, the cooling holes 322 are provided on the downstream side of the inwardly projecting portions 324 with respect to the flow direction of the air-fuel mixture in the interior of the combustion liner 320. The combustion liner 320 includes a plurality of relatively straight sections 321 which connect each of the inwardly projecting portions 324. On the inner surface of the combustion liner 320, pockets are formed between adjacent ones of the inwardly projecting portions 324. The cooling air entering the interior of the combustion liner 320 through the cooling holes 322 tends to travel along this pocket, and thus along the inner side of the straight sections 321 of the combustion liner 320. This helps to form a film of cool air which serves to reduce the temperature of the combustion liner 320.

The location and inclination of the cooling holes 322 on the downstream side of the inwardly projecting portions 324 also helps to direct the cooling air along the inner surface of the straight sections 321. Cooling air that has entered the interior of a combustion liner 320 and that has traveled along a straight section 321 ultimately impinges upon the next downstream inwardly projecting portion 324, which deflects the cool air toward the interior of the combustion liner 320.

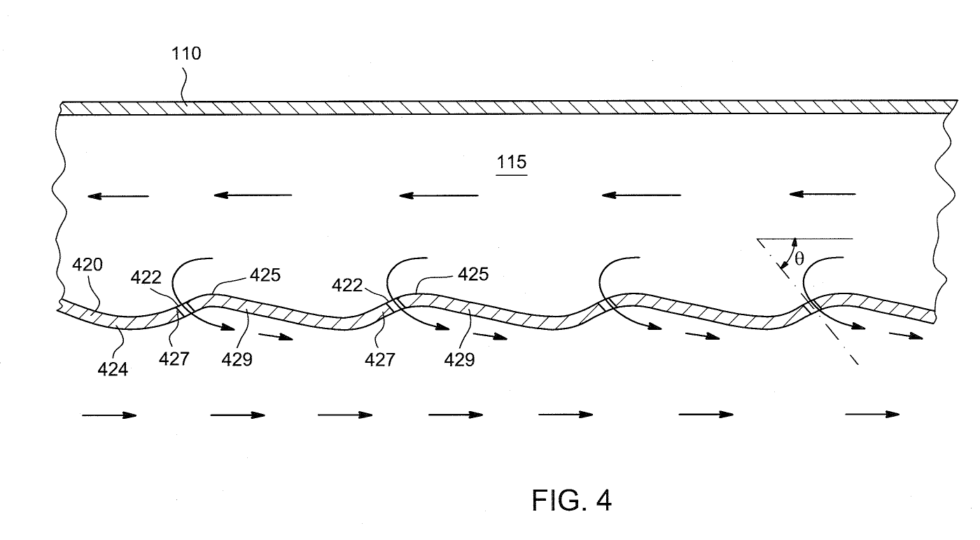

A second embodiment of a combustion liner 420 is illustrated in FIG. 4. In this embodiment, the undulations in the combustion liner 420 are formed of inwardly projecting portions 424, outwardly projecting portions 425, and inclined portions 427, 429, which connect the inwardly projecting portions 424 and the outwardly projecting portions 425.

As illustrated in FIG. 4, cooling holes 422 are located on the inclined portions 427 on the downstream side of each of the inwardly projecting portions 424. Here again, the location and inclination of the cooling holes 422 helps to direct a flow of cool air entering the interior of the combustion liner 420 along the inner surface of combustion liner. Specifically, the cool air is directed along the inner surface of the inclined portions 429 located on the downstream side of the outwardly projecting portions 425. Thus, the location and inclination of the cooling holes 422 helps to form a film of cool air along the inner surface of the combustion liner 420.

As also illustrated in FIG. 4, a centerline of the cooling holes 422 forms an angle θ with respect to a line that is parallel to a centerline of the combustion liner 420. The angle θ is preferably in the range of approximately 15° to approximately 75°. This same general range for the angle θ applies to all of the disclosed embodiments.

A combustion liner of a turbine engine used in the electrical power generation field can have cooling holes 422 with a diameter in the range of approximately 0.03 inches to 0.12 inches. This cooling hole diameter range applies to all of the disclosed embodiments. However, other cooling hole diameters might also be appropriate depending on the overall dimensions of the combustion liner.

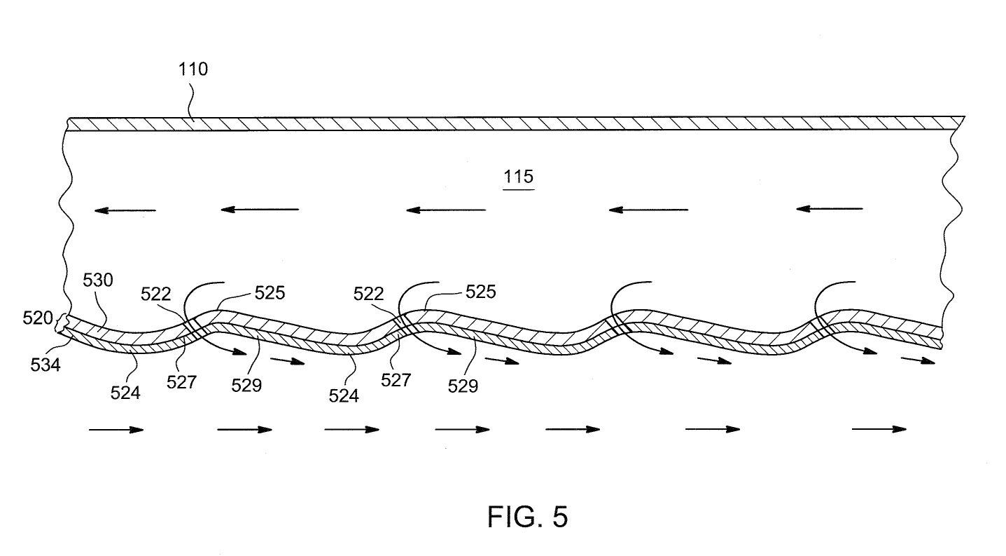

FIG. 5 illustrates another embodiment similar to the one just described in connection with FIG. 4. In this embodiment, however, a thermal barrier coating 534 is applied to the inner surface of an outer metal layer 530 of the combustion liner 520. The thermal barrier coating 534 also helps to protect the combustion liner from the heat of combustion in the interior of the combustion liner. As illustrated in FIG. 5, the cooling holes 522 pass through both the exterior metal layer 530 and the thermal barrier coating 534 located on the inner surface of the metal layer 530.

In the embodiments illustrated in FIGS. 4 and 5, the inclined portions 427/527 located on the upstream side of each outwardly projecting portion 425/525 are sloped at a greater angle relative to the central longitudinal axis of the combustion liner than the inclined portions 429/529 on the downstream side of each outwardly projecting portion 425/525. The cooling holes 422/522 are formed through the greater sloped inclined portions 427/527.

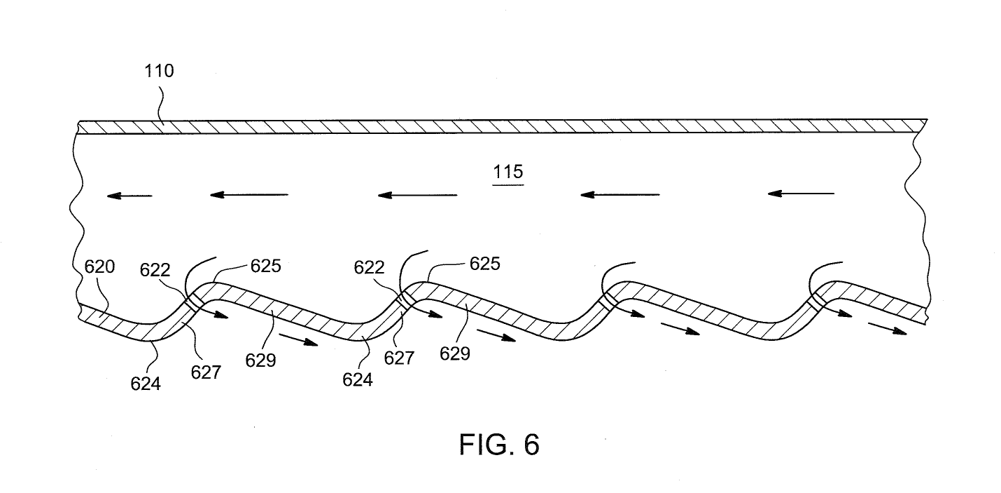

FIG. 6 illustrates another embodiment of a combustion liner which is similar to the one described above in connection with FIG. 4. However, in this embodiment, the inclined portions 627, 629 have a greater slope or angle of inclination relative to the central longitudinal axis than the embodiment illustrated in FIG. 4. This creates larger pockets to receive the cooling air. In addition, the cooling holes can be angled more steeply to better direct the cooling air along the inner surface of the inclined portions 629 located on the downstream side of the outwardly projecting portions 625.

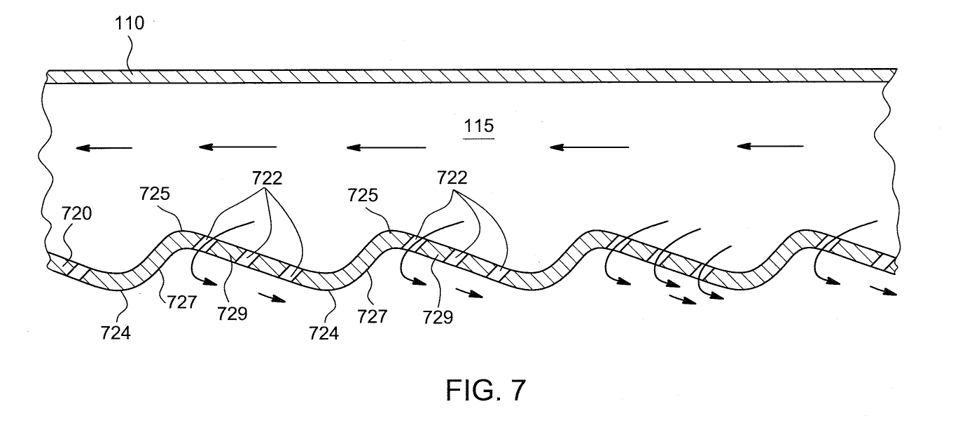

FIG. 7 illustrates another embodiment of a combustion liner which is similar to the one illustrated in FIG. 6. However, in this embodiment, the cooling holes 722 are located on the inclined portions 729 on the downstream side of each outwardly projecting portion 725. Also, multiple rows of cooling holes 722 are provided in each undulation. The airflow entering into the interior of the combustion liner 720 through the cooling holes 722 then turns after it enters so that the cooling air flows along the remaining portions of the inner wall of the inclined portions 729. In this embodiment, it may be possible to cause a greater amount of compressed air to flow through the cooling holes 722 than in the embodiment illustrated in FIG. 6 because the cooling holes 722 are better oriented with respect to the original flow direction within the annular space 115.

While the embodiments discussed above were for the combustion liner surrounding a primary combustion zone of a combustor, the same design is applicable to the combustion liner surrounding a secondary combustion zone located downstream of a venturi.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A combustion liner for a combustor of a turbine engine, comprising:
a generally cylindrical liner that includes a plurality of undulations, each undulation extending around a circumference of the cylindrical liner, each undulation including a portion that extends inward toward a central longitudinal axis of the cylindrical liner, and wherein no louvers or inner rings are mounted on an inner surface of the cylindrical liner; and
a plurality of cooling holes that extend through the cylindrical liner, the cooling holes being arranged in a plurality of rows, each row of cooling holes being provided in one of the undulations.

2. The combustion liner of claim 1, wherein each of the undulations comprises a rounded inwardly protruding portion that extends inward toward a central longitudinal axis of the cylindrical liner.

3. The combustion liner of claim 2, wherein each row of cooling holes is located on a downstream side of a rounded inwardly protruding portion with respect to a flow direction of gases passing though the interior of the combustion liner.

4. The combustion liner of claim 1, wherein each of the undulations comprises:
an inwardly protruding portion that extends inward towards the central longitudinal axis;
an outwardly protruding portion that extends outward away from the central longitudinal axis; and
inclined portions that join alternating inwardly protruding portions and outwardly protruding portions.

5. The combustion liner of claim 4, wherein the inclined portions located on the upstream side of each outwardly protruding portion with respect to a flow direction of gases passing through the interior of the combustion liner is sloped at a greater angle with respect to the central longitudinal axis than the inclined portions located on the downstream side of each outwardly protruding portion.

6. The combustion liner of claim 4, wherein each row of cooling holes is located in an inclined portion on the upstream side of each outwardly protruding portion with respect to a flow direction of gases passing through the interior of the combustion liner.

7. The combustion liner of claim 6, wherein the inclined portions located on the upstream side of each outwardly protruding portion are sloped at a greater angle with respect to the central longitudinal axis than the inclined portions located on the downstream side of each outwardly protruding portion.

8. The combustion liner of claim 4, wherein each row of cooling holes is located in an inclined portion on the downstream side of each outwardly protruding portion with respect to a flow direction of gases passing through the interior of the combustion liner.

9. The combustion liner of claim 8, wherein the inclined portions located on the upstream side of each outwardly protruding portion is sloped at a greater angle with respect to the central longitudinal axis than the inclined portions located on the downstream side of each outwardly protruding portion.

10. The combustion liner of claim 1, further comprising a thermal barrier coating on the inner surface of the cylindrical liner.

11. A method of forming a combustion liner for a combustor of a turbine engine, comprising:
providing a generally cylindrical liner;
forming a plurality of undulations in the liner, each undulation extending around a circumference of the cylindrical liner, each undulation including a portion that extends inward toward a central longitudinal axis of the cylindrical liner, and wherein no louvers or inner rings are mounted on an inner surface of the cylindrical liner; and
forming a plurality of cooling holes in the liner, the cooling holes extending through the cylindrical liner, the cooling holes being arranged in a plurality of rows, each row of cooling holes being provided in one of the undulations.

12. The method of claim 11, wherein the step of forming a plurality of undulations comprises modifying the shape of the cylindrical liner to include a plurality of rounded inwardly protruding portions that extend inward toward a central longitudinal axis of the cylindrical liner.

13. The method of claim 12, wherein the step of forming a plurality of cooling holes comprises locating the cooling holes on the downstream side of the rounded inwardly protruding portions with respect to a flow direction of gases passing though the interior of the combustion liner.

14. The method of claim 11, wherein the step of forming a plurality of undulations comprises forming each undulation to include an inwardly protruding portion that extends inward towards the central longitudinal axis, an outwardly protruding portion that extends outward away from the central longitudinal axis, and inclined portions that join alternating inwardly protruding portions and outwardly protruding portions.

15. The method of claim 14, wherein the step of forming a plurality of undulations further comprises forming the undulations such that the inclined portions located on the upstream side of each outwardly protruding portion with respect to a flow direction of gases passing through the interior of the combustion liner is sloped at a greater angle with respect to the central longitudinal axis than the inclined portions located on the downstream side of each outwardly protruding portion.

16. The method of claim 14, wherein the step of forming a plurality of cooling holes comprises locating each row of cooling holes on an inclined portion on the upstream side of each outwardly protruding portion with respect to a flow direction of gases passing through the interior of the combustion liner.

17. The method of claim 16, wherein the step of forming a plurality of undulations further comprises forming the undulations such that the inclined portions located on the upstream side of each outwardly projecting portion is sloped at a greater angle with respect to the central longitudinal axis than the inclined portions located on the downstream side of each outwardly projecting portion.

18. The method of claim 14, wherein the step of forming a plurality of cooling holes comprises locating each row of cooling holes on an inclined portion on the downstream side of each outwardly projecting portion with respect to a flow direction of gases passing through the interior of the combustion liner.

19. The method of claim 18, wherein the step of forming a plurality of undulations further comprises forming the undulations such that the inclined portions located on the upstream side of each outwardly projecting portion is sloped at a greater angle with respect to the central longitudinal axis than the inclined portions located on the downstream side of each outwardly projecting portion.

20. The method of claim 11, further comprising applying a thermal barrier coating on the inner surface of the cylindrical liner.
